(19) United States
(12) Patent Application Publication
(10) Pub. No.: US 2021/0107436 A1
(43) Pub. Date: Apr. 15, 2021

(54) Virtually, Waterless, Soapless and Brushless, Tunnel Car Washing System.

(71) Applicant: Christi Love-Curtis, Los Angeles, CA (US)

(72) Inventor: Christi Love-Curtis, Los Angeles, CA (US)

(21) Appl. No.: 16/598,980

(22) Filed: Oct. 10, 2019

(51) Int. Cl. B60S 3/04; B08B 3/02

(52) U.S. Cl. CPC B60S 3/04; B60S 3/004; B08B 3/022

(57) ABSTRACT

This Invention, a virtually waterless, soapless and brushless, tunnel car wash system improves traditional professional car washing methods by using less water, no soap and no brushes. The waterless cleaning formula that is used in this system is presently only available for hand use in spray bottles. The “Prep-Tunnel” prepares the car for formula application through an automated, quick and convenient process. Together the car wash tunnel equipment and the formula work to “prep” the car by pre-rinsing, drying and cooling the car so that the formula is best applied for optimal cleaning, waxing and shining results. This new system will save on water, chemical and labor cost while delivering a car that is cleaned, waxed, coated, sealed and protected.

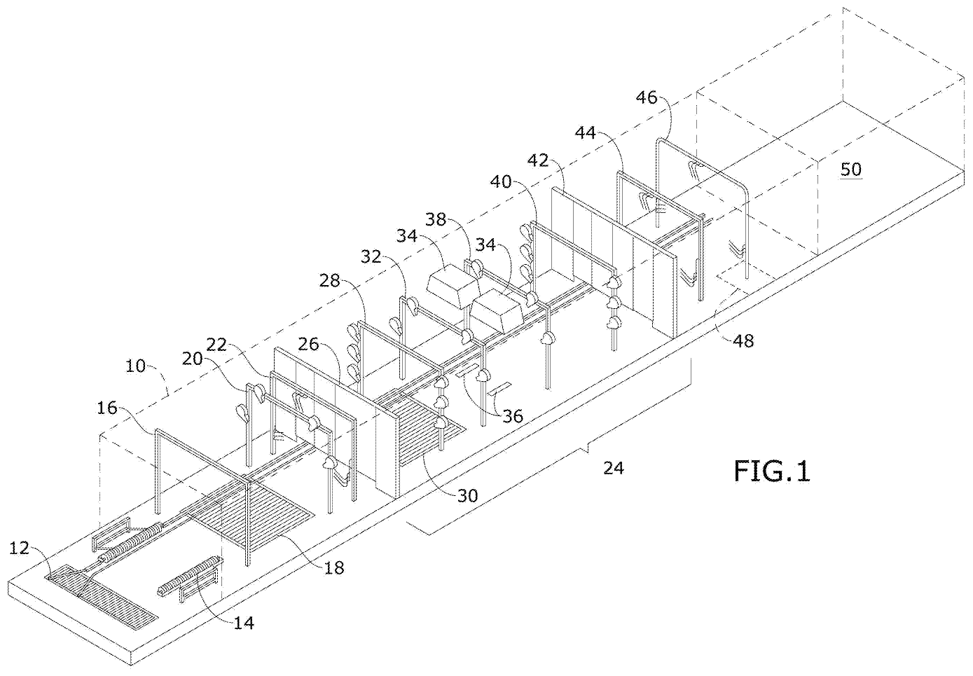

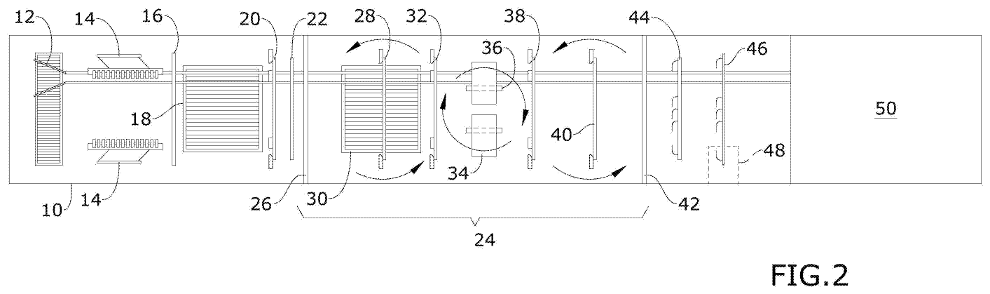

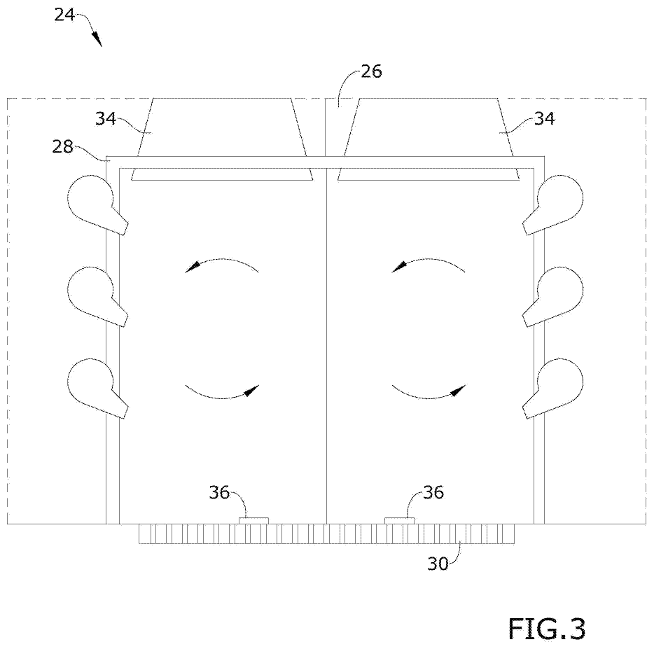

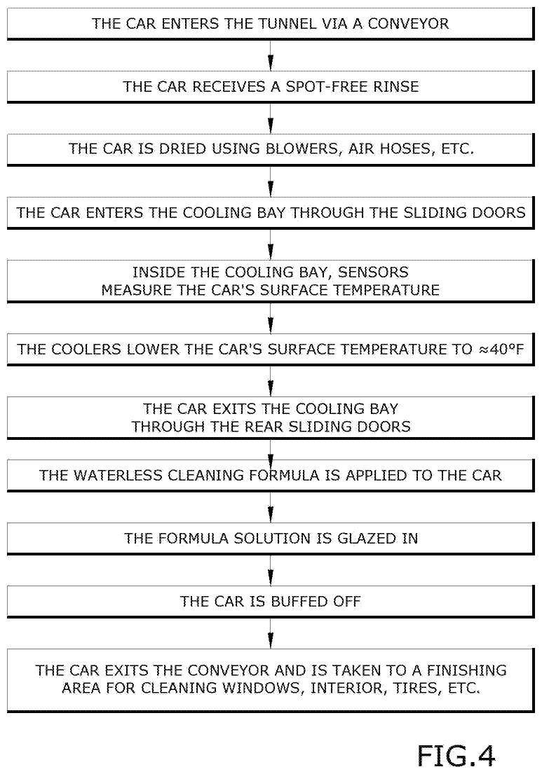

### BACKGROUND OF THE INVENTION

Principal Use or Uses of the Invention:

Professional Commercial Car Wash.

Problem:

Professional car washes use gallons of recycled water which is not sustainable. Professional systems also use soap which is damaging to cars paint after time. Brushes used in traditional car wash systems can damage the cars paint by creating micro scratches and permanent swirl markings.

Problem Solved:

A virtually waterless, soapless and brushless system, which saves gallons of water, eliminates damage by soaps, detergents, water and brushes used in traditional car wash tunnel systems.

### DETAILED DESCRIPTION OF THE INVENTION

This Tunnel System uses the least amount of water of any professional car wash tunnel system. Only a quick rinse is necessary in this professional application. It helps reduce damage done to car while in traditional car wash tunnel systems by eliminating the use of soap and brushes. Helps keep chemicals from entering storm drains, rivers and oceans.

Helps avoid damage and liability from brushes and moving parts of traditional car wash tunnels. Helps protect car's finish by providing a protective coat that cleans, waxes, coats, seals and protects in one application.

Most car wash tunnel systems use soap, water and brushes. There is no soap or brushes used in this tunnel system while using the least amount of water than any professional car wash tunnel system. One initial recycled, soft-water rinse is the only water used throughout. This system utilizes a patented car wash formula instead of soap, water and brushes. The tunnel is specially designed to help prep the car for a quick automated application. Our formula cleans, waxes, coats and protects the car's paint and leaves car's paint surface in better condition than with soap and water. It is also brush-less which protects car from swirl marks and mechanical damage.

Traditional car wash system professionals are looking for ways to become more sustainable while delivering a less damaged vehicle to the customer/consumer.

Our tunnel system works by using a formula and a tunnel system that helps to prepare the car for optimal, automated formula application. The formula puts the car's paint surface in better condition than soap and water. There are virtually no moving parts so there is less damage to car and tunnel equipment. The tunnel provides “prepping” so that the application of the formula is automated and fast. Without the automated tunnel the process has to be done by hand and is slower.

A liquid formula that cleans, waxes, coats, seals and protects the cars finish is used with the components of the tunnel to create this new automated car washing system.

The Version of the Invention Discussed Here Includes:

The Tunnel (10) and the Formula (48) work together as a system.

The “Cooling Bay” (step 24.) helps accelerate the “cooling down” process so that the Formula can best be applied to a cooled, bone-dry car.

The “Formula Tank and Mixer,” (48.) helps to automatically mix and measure each application.

The “Formula Sprayers,” (46.) deliver the formula in a precise application.

Relationship Between the Components:

Reference numbers of the main technical features placed between parentheses:

(10.) Overall Tunnel, (12.) Tunnel Conveyor, (14.) The Wheel Wash, (16.) Soft Water Rinse Arch, (18.) Undercarriage Grate, (20.) Air Blower, (22.) Air Hoses, (24.) Cooling Bay (26.) Sliding Doors, (28.) Air Curtain/Blowers, (30.) Second Undercarriage Grate, (32.) First Cooling Bay Air Blower Arch, (34.) Air Coolers, (36.) Temperature Sensors, (38.) Second Cooling Bay Air Blower Arch, (40.) Second Air Curtain/Blowers, (42.) Sliding Doors, (44.) Second Air Hose Arch (46.) Formula Sprayer Arch, (48.) Formula Tanks, (50.) Finishing Area.

How the Invention Works:

Steps of Invention:

(Step 1.) The car enters the tunnel via conveyor, (2.) The car receives a spot-free rinse, (3.) The car is dried using air blowers, air hoses, etc., (4.) The car enters the “Cooling Bay,” via sliding doors, (5.) Inside “Cooling Bay” sensors detect cars surface temperature, (6.) The coolers lower cars surface temperature to approximately 40*degrees, (7.) The car exits the Cooling Bay through sliding rear doors, (8.) Our cleaning solution is then applied to car, (9.) The solution is glazed in, (10.) The solution is then buffed off (11.) The car exits the conveyor and is taken to a finishing area.

How to Make the Invention:

To construct this tunnel system, one would contact a professional, commercial car wash equipment company that specializes in conveyor systems and have them install said system onto the car wash property.

The Cooling Bay System installation would follow including sliding doors. This would require a professional car wash air-dryer company to install the drying system, an HVAC Engineer to install a commercial heating and cooling system with temperature sensors and a commercial door company to install sliding doors.

Next would come the traditional car wash equipment such as rinse arches, undercarriage grate, air hose arches, etc. This would be supplied by a manufacturer specializing in car wash equipment parts.

Our waterless solution/formula tanks are placed at the end of the tunnel to allow for application by professional compressed air sprayers to apply to a perfectly “prepped” automobile. The formula is applied by hand sprayers, gently glazed in and buffed by micro-fiber towel to a shine.

How to Use the Invention:

This is a professional commercial application, used by car wash technicians in a professional car wash setting. The tunnel system is to be used like any traditional full-service car wash tunnel system.

All elements a the Invention are necessary for our ftd Lscale model but plans for a scaled-down version are underway.

None of the elements are optional for this full-scale model.

At this time, no known elements could be added to make the Invention work better.

In our Express Version of the Invention, the Cooling Bay can be omitted. This would create a shorter tunnel with a shorter conveyor belt. This would be a less expensive overall cost.

This invention cannot be used in a different way or in another field of technology.

This invention does not produce a product, device, composition, or other useful item.

1. A virtually waterless, soapless and brushless tunnel car washing system, comprising:
(1.) A Conveyor, (2.) A Rinsing Component, (3.) A Drying and Cooling Component, (4.) A Waterless Formula delivered through an automatic application process.
